(19) United States
(12) Patent Application Publication
(10) Pub. No.: US 2010/0069086 A1
(43) Pub. Date: Mar. 18, 2010

(54) Mobile Terminals Providing Network-Based Location Data, and Methods and Computer Program Product for Operating the Same

(75) Inventor: Eskil Gunnar Ahlin, Dorrod (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/212,109

(22) Filed: Sep. 17, 2008

(51) Int. Cl. H04Q 7/20

(52) U.S. Cl. 455/456.1

(57) ABSTRACT

A mobile terminal includes a position cache that is operable to store a plurality of location data sets corresponding to wireless networks that are associated with a wireless telecommunication node in a telecommunication network when the mobile terminal is connected to the wireless telecommunication node. The mobile terminal includes a wireless network transceiver that is operable to receive wireless network identification signals from at least one of the wireless networks when the mobile terminal is proximate the wireless network and a position module that is operable to determine a geographical location of the mobile terminal corresponding to a location data sets that corresponds to the wireless network.

### BACKGROUND OF THE INVENTION

The present invention relates to mobile terminals and methods of operating the same and, more particularly, to providing location data using a mobile terminal.

The Global Positioning System (GPS) is a space-based radio triangulation system using a constellation of satellites in orbit around the earth. A GPS receiver triangulates its position based on timing of radio signals it receives from various ones of the satellites and the known location of those satellites. Determining the position of a GPS receiver typically requires the acquisition of a set of navigational parameters from the navigational data signals of four or more GPS satellites. Although many mobile terminals are equipped with GPS capability, many are not. For example, many conventional mobile terminals do not include GPS receivers, such as, mobile phones, Personal Digital Assistants (PDA), Personal Computers (PC) or the like.

Additionally, performance of GPS based positioning may be limited by environmental conditions. For example, GPS performance may be degraded in metropolitan areas with significant overhead structures that may obscure the line-of-sight connection between one or more satellites and the receiver.

### SUMMARY OF THE INVENTION

According to some embodiments of the present invention, a mobile terminal includes a position cache that is operable to receive, from a cellular network, a plurality of location data sets corresponding to multiple wireless local area networks (WLANs) that are associated with one of multiple cells in the cellular network when the mobile terminal is connected to the one of the cells and a wireless network transceiver that is operable to receive WLAN identification signals from at least one of the WLANs when the mobile terminal is within range of a transceiver of the at least one of the WLANs. Some embodiments of a mobile terminal include a position module that is operable to determine, from the position cache, a geographical location of the mobile terminal corresponding to at least one of the location data sets that corresponds to the at least one WLAN responsive to the received WLAN identification signals.

Some embodiments include a telecommunication network transceiver that is operable to query a database at the cellular network that includes the location data sets corresponding to the WLANs that are associated with the cells in the cellular and to receive the location data sets.

In some embodiments, each of the location data sets includes an identification of the corresponding one of the WLANs and the geographical location of the corresponding one of the WLANs. Some embodiments provide that the WLANs include WiFi networks, the identification includes a service set identifier (SSID) and/or a media access control (MAC) address, and the geographical location includes a longitude value and a latitude value.

Some embodiments provide that the position cache is further operable to store validation data that corresponds to the location data sets corresponding to the WLANs that are associated with the one of the cells and include a validation module that is operable to use the validation data to determine if the location data sets are valid responsive to a subsequent reconnection to the one of the cells. Some embodiments provide that if the location data sets stored in the position cache are valid then a telecommunication network transceiver in the mobile terminal does not query a database at the cellular network.

In some embodiments, the validation data includes at least one hash value formed from the location data sets. Some embodiments provide that the validation data includes a timestamp that corresponds to a latest update to the location data sets. In some embodiments, the validation data includes an update counter value that increments when the data sets are updated.

In some embodiments, the ones of the location data sets corresponding to ones of the WLANs are associated with another one of the cells in the cellular network. Some embodiments provide that the position cache includes a first-in first-out (FIFO) prioritization scheme and the position cache is operable to discard the location data sets corresponding to a storage time that exceeds a predefined data validity period.

Some embodiments include a graphical image generator that is configured to generate a graphical image that includes the geographical location relative to previously mapped locations and a user display that is operable to display the generated graphical image. In some embodiments, the previously mapped locations are determined via a map data source that provides map data to the mobile terminal via at least one of the WLANs and/or at least one of the cells.

Some embodiments include methods of providing location data using a mobile terminal. Embodiments of such methods include storing, in a mobile terminal position cache, identities and corresponding geographical locations for each of multiple wireless networks that correspond to one of multiple wireless telecommunication nodes in a wireless telecommunication network responsive to communication with the one of the wireless telecommunication nodes. Methods may include receiving at least one wireless network identification signal from one of the wireless networks and determining a geographical location of the mobile terminal as a function of the geographical location corresponding to the at least one wireless network signal.

Some embodiments include, before storing, sending, via a telecommunication network transceiver in the mobile terminal, a query from the mobile terminal to a database that includes the identities and corresponding geographical locations and receiving, via the telecommunication transceiver, the identities and corresponding geographical locations for each of the wireless networks that correspond to the one of the wireless telecommunication nodes.

Some embodiments include validating stored identities and corresponding geographical locations that correspond to the one of the wireless telecommunication nodes responsive to subsequent reconnection to the one of the wireless telecommunication nodes. In some embodiments, validating includes comparing a first validation value stored corresponding to storing the identities and corresponding geographical locations and a second validation value received responsive to the subsequent reconnection.

In some embodiments, the first and second validation values include first and second checksum values of the identities and corresponding geographical locations, first and second update counters corresponding to the identities and corresponding geographical locations and/or first and second update timestamps corresponding to the identities and corresponding geographical locations.

Some embodiments include receiving map data from a map data source via at least one of the wireless networks and/or at least one of the wireless telecommunication nodes and graphically displaying the geographical location of the mobile terminal in a context of corresponding map data that is received from the map data source.

Some embodiments include computer program products for carrying out the methods and/or operations described herein. Such computer program products may include a computer usable storage medium having computer readable program code embodied in the medium, the computer readable program code configured to carry out the methods and/or operations described herein.

Some embodiments of the present invention include methods of providing location data using a mobile terminal. Such methods may include associating identities and corresponding geographical locations for each of multiple wireless networks with corresponding ones of multiple telecommunication nodes in a telecommunication network. Methods may include communicating with the mobile terminal via a first telecommunication node and sending, to the mobile terminal, ones of the identities and geographical locations corresponding to the first telecommunication node responsive to communicating with the mobile terminal.

The present invention may include embodiments of methods of using a mobile terminal. Such methods may include storing, in a mobile terminal position cache, identities and corresponding geographical locations for each of multiple wireless networks that correspond to one of multiple wireless telecommunication nodes in a wireless telecommunication network responsive to communication with the one of the wireless telecommunication nodes. Methods may include determining a geographical location of the mobile terminal using signals received from an extra-terrestrial positioning system transmitter and comparing the geographical location of the mobile terminal to the geographical locations for each of the wireless networks. Methods may further include enabling a wireless network transceiver in the mobile terminal responsive to proximity to one of the plurality of wireless networks.

Other electronic devices, methods, and/or computer program products according to embodiments of the invention will be or become apparent to one with skill in the art upon review of the following drawings and detailed description. It is intended that all such additional electronic devices, methods, and computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiments of the invention. In the drawings:

FIG. 1 is a block diagram of a multi-node terrestrial communication system that includes exemplary location determination in accordance with some embodiments of the present invention;

FIG. 2 is a block diagram of a single node in a multi-node terrestrial communication system and multiple wireless networks that are associated with the single node in accordance with some embodiments of the present invention;

FIGS. 3 and 4 are tables representing a location data database and a report that is responsive to a query thereof, respectively, in accordance with some embodiments of the present invention;

FIG. 5 is a block diagram that illustrates a mobile terminal in accordance with some embodiments of the present invention;

FIGS. 6-10 are flowcharts that illustrate operations of using the mobile terminal of FIG. 5 in accordance with some embodiments of the present invention.

### DETAILED DESCRIPTION

The present invention will be described more fully hereinafter with reference to the accompanying figures, in which embodiments of the invention are shown. This invention may, however, be embodied in many alternate forms and should not be construed as limited to the embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components, but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to another element, there are no intervening elements present. As used herein the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. Although some of the diagrams include arrows on communication paths to show a primary direction of communication, it is to be understood that communication may occur in the opposite direction to the depicted arrows.

Some embodiments are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

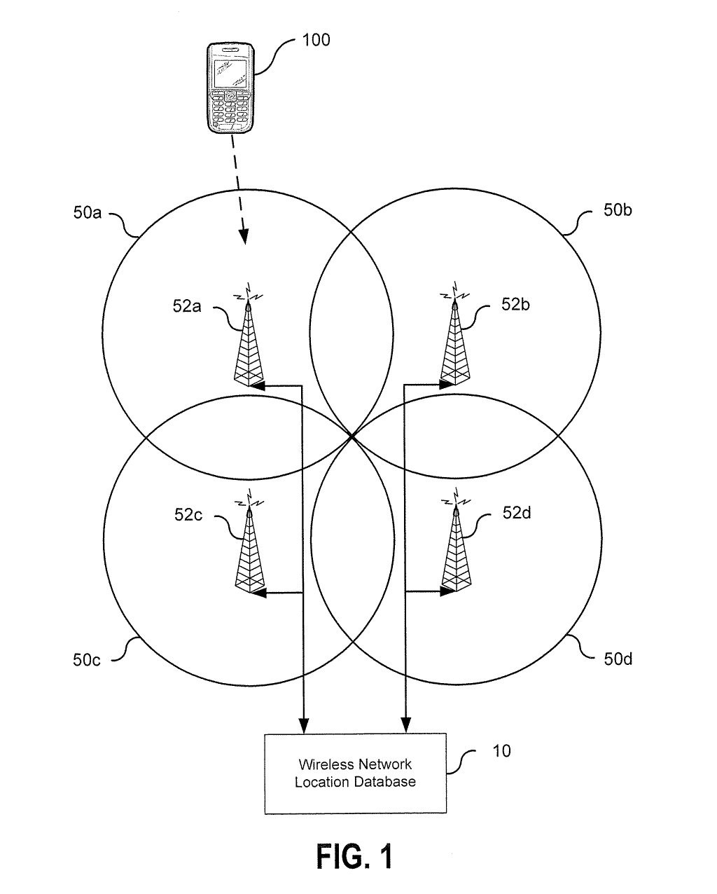

Reference is now made to FIG. 1, which is a block diagram of a multi-node terrestrial communication system that includes exemplary location determination in accordance with some embodiments of the present invention. A mobile terminal 100 can include a cellular transceiver that can communicate with a plurality of cellular base stations 52a-d, each of which provides cellular communications within their wireless telecommunication nodes (cells) 50a-d. In some embodiments, each of the nodes 50a-d may be telecommunication cells in a wireless telecommunication network. Each of the cellular base stations 52a-d may communicate with a wireless network location database 10, among others. For example, each of the cellular base stations 52a-d may also communicate with a mobile telephone switching office (not illustrated). As a mobile terminal 100 enters a node 50a, the wireless network location database 10 may be queried via the cellular base station 52a to determine wireless network location data that is associated with the node 50a. Although FIG. 1 illustrates an exemplary telecommunication network, it will be understood that the present invention is not limited to such configurations, but is intended to encompass any configuration capable of carrying out the operations described herein.

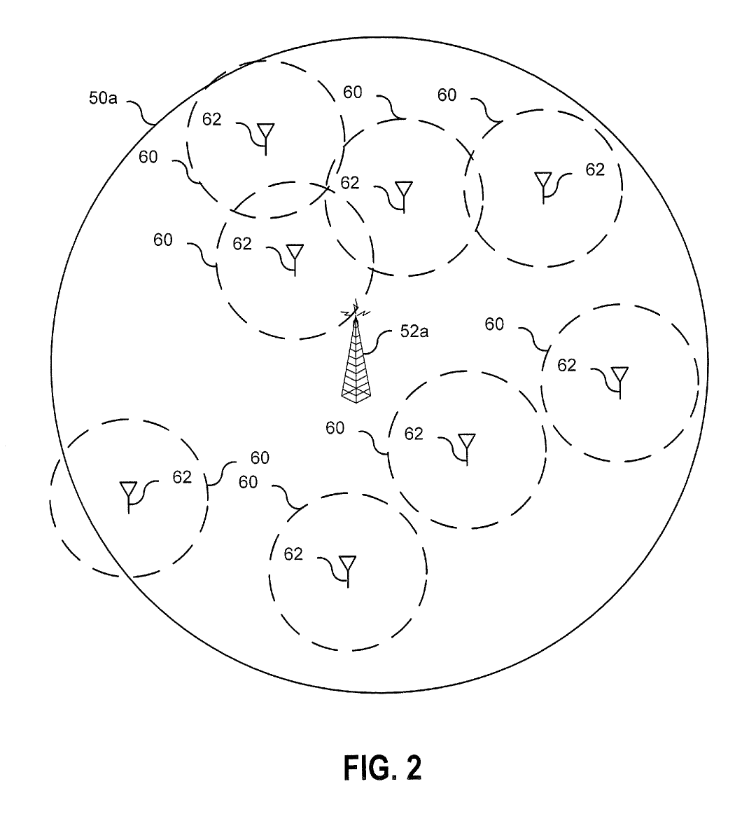

Brief reference is now made to FIG. 2, which is a block diagram of a single wireless telecommunication node (cell) 50a in a multi-node telecommunication network and multiple wireless networks that are associated with the node 50a in accordance with some embodiments of the present invention. In some embodiments, wireless networks 60 may include WiFi networks as defined under IEEE 802.11, among others. The node 50a may be associated with multiple wireless networks 60 that are located within the node 50a. Each of the wireless networks 60 may include a wireless network transceiver 62 that is operable to communicate via one or more wireless network devices, including, but not limited to, fixed position wireless and/or wired network clients and/or resources, mobile phones, Personal Digital Assistants (PDA), Personal Computers (PC) or the like. Each of the wireless networks 60 within a node 50a may be further associated with a geographical location.

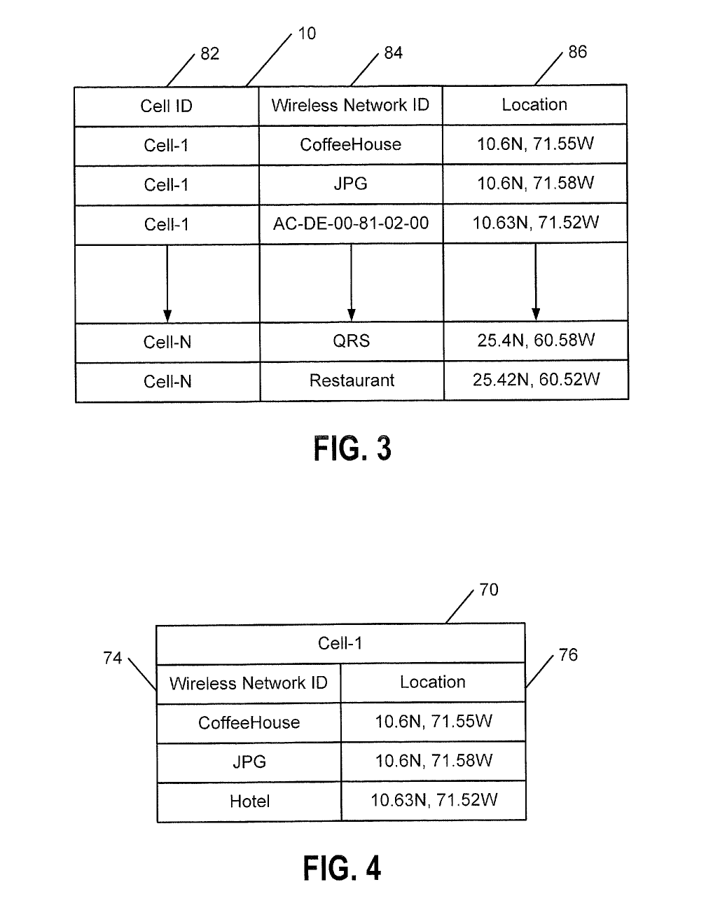

Some embodiments provide that a wireless network location database 10 may include information that defines the associations corresponding to the node 50a, a wireless network identifier and the wireless network geographical location. For example, reference is now made to FIGS. 3 and 4, which are tables representing a wireless network location database 10 and report 70 that is responsive to a query thereof, respectively in accordance with some embodiments of the present invention. Referring to FIG. 3, a wireless network location database 10 includes location data sets each having an entry corresponding to a cell identification 82, wireless network identification 84 and geographical location 86 that are associated with one another. Since cells in a telecommunication network may geographically overlap, some wireless networks 60 may be associated with more than one cell.

In some embodiments, the wireless network identification 84 can be a service set identifier (SSID) and/or a media access control (MAC) address of a wireless computer network. The geographical location 86 may be expressed in terms of, for example, a pair latitude and longitude coordinates. The wireless network location database 10 can include the identities of wireless networks and their geographical locations for many different cells. For example, the wireless network location database 10 may include data corresponding to cells within a specified geographical region and/or within a specific telecommunications network.

Upon entering a cell 50a, a mobile terminal 100 may query the wireless network location database 10 for the identities of wireless networks 60 and their respective locations that are within and/or associated with that cell 50a. The database 10 may transmit a responsive report 70 that includes the requested information.

Some embodiments provide that the database 10 may be populated and/or updated by inviting wireless network providers to register and/or be included in the database 10. In some embodiments, the database 10 may be populated by location enabled mobile terminals 100 that receive the wireless network identification data and can provide that identification data along with a geographical location to the database 10.

Referring to FIG. 4, when the mobile terminal 100 enters a cell designated as Cell-1, the mobile terminal 100 may receive a responsive report 70 to the query that includes the wireless network identifiers 74 and their corresponding geographical locations 76. In this manner, when the mobile terminal 100 receives a signal from one of the wireless networks associated with the cell, the mobile terminal 100 can instantly access its stored location data to determine its geographical location without any subsequent communications and/or delay associated therewith. In addition to providing nearly instantaneous geographical location information, by storing the location data in the mobile terminal 100 the load on the telecommunication network is reduced by minimizing the number of times the mobile terminal 100 accesses the wireless network location database 10.

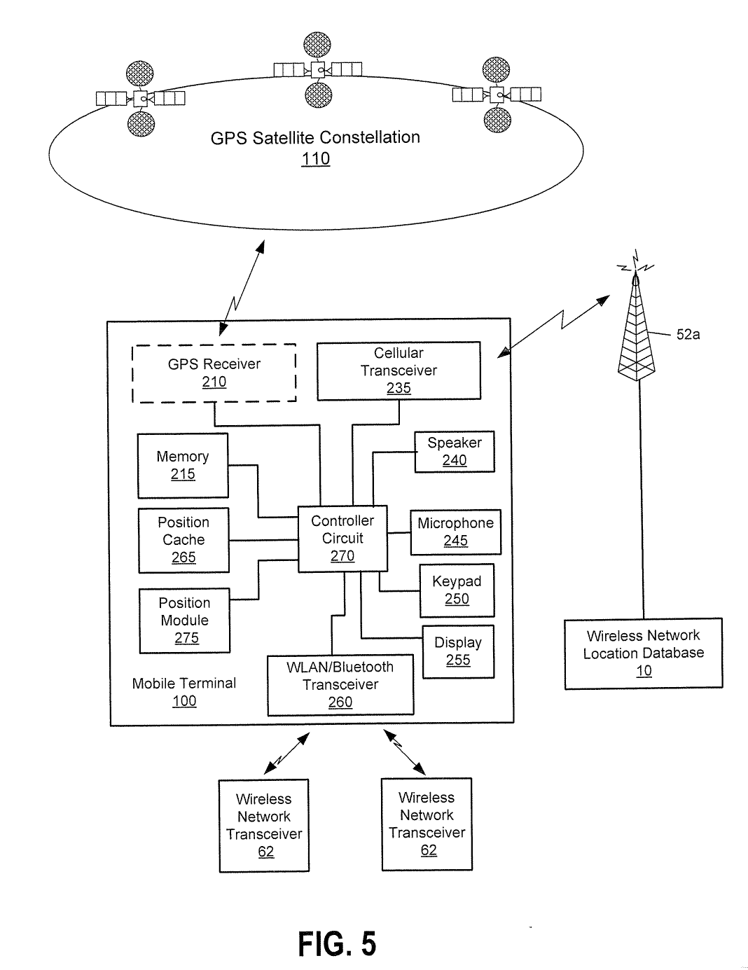

Reference is now made to FIG. 5, which is a block diagram that illustrates a mobile terminal in accordance with some embodiments of the present invention. The mobile terminal 100 optionally includes a GPS receiver circuit 210 that is operable to receive GPS radio signals from visible satellites in a GPS satellite constellation 10. The GPS receiver circuit 210 is operable to measure the time that the radio signals take to travel from the respective GPS satellites 110 to the mobile terminal 100. By multiplying the travel time by the propagation speed, the GPS receiver circuit 210 calculates a range for each satellite 110 in view. Ephemeris information provided in the GPS radio signal describes the satellite's orbit and velocity, thereby enabling the GPS receiver circuit 210 to calculate the position of the mobile terminal 100 through a process of triangulation.

The mobile terminal 100 may include memory 215 and a controller circuit 270 that communicates with the memory 215 via an address/data bus. The controller circuit 270 may be, for example, a commercially available or custom microprocessor. The memory 215 is representative of the one or more memory devices containing the software and data used to operate the mobile terminal 100. The memory 215 may include, but is not limited to the following types of devices: cache, ROM, PROM, EPROM, EEPROM, flash, SRAM, and DRAM.

The mobile terminal 100 includes a cellular transceiver 235, a speaker 240, a microphone 245, a keypad 250, a display 255, and a WLAN/Bluetooth transceiver 260 that communicate with a controller circuit 270. The cellular transceiver 235 can be configured to encode/decode and control communications according to one or more cellular protocols, which may include, but are not limited to, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS). The foregoing components of the mobile terminal 100 may be included in many conventional mobile terminals and their functionality is generally known to those skilled in the art.

In accordance with some embodiments, the mobile terminal 100 includes a position cache 265 that is operable to store location data sets corresponding to wireless networks 60 that are associated with the cell 50a in which the mobile terminal 100 is located in and/or in communication with. For example, when the mobile terminal 100 enters a cell 50a, the mobile terminal 100 queries a wireless network location database 10 via a cellular base station 52a using the cellular transceiver 235. Responsive to the query, the wireless network location database 10 transmits location data sets to the mobile terminal 100. In some embodiments, the position cache 265 is a FIFO organized memory that retains the most recent information and discards the oldest information as new data is received. Some embodiments provide that the position cache 265 is operable to discard stored data based on a specified window of data validity.

The mobile terminal 100 includes a position module 275 that is operable to determine a geographical location of the mobile terminal 100 that corresponds to one of the location data sets. For example, as the mobile terminal 100 traverses the cell 50a, it may receive wireless network identification information from various wireless network transceivers 62 via the WLAN/Bluetooth transceiver 260. The position module 275 can compare the received wireless identification information with the location data sets stored in the position cache 265. If the received wireless identification information corresponds to an entry in the location data set, then the mobile terminal 100 can determine that it is at the geographic location corresponding to that wireless network 60.

In some circumstances, the mobile terminal 100 may re-enter a previously entered cell 50a. In this regard, the position cache 265 may be further operable to store validation data corresponding to the location data sets that were received resulting from the previous experience with the cell 50a. In this regard, the mobile terminal 100 may optionally include a validation module (not illustrated) that is operable to use the validation data to determine if the stored location data is valid. If the stored location data is valid, then the wireless network location database 10 will not send the location data to the mobile terminal 100 again, thus reducing the amount of data transmitted therebetween. For example, in some embodiments, the mobile terminal 100 may not request the location data from the cellular network when it determines that it has re-entered a cell 50a. If the stored location data is not valid, then the wireless network location database 10 will transmit the location data sets to the mobile terminal 100 for storage in the position cache 265.

Some embodiments provide that the validation data includes a compressed value that represents the location data sets. For example, a fingerprint and/or a checksum of the location data sets may be generated and stored for comparison with future location data sets. In some embodiments, the validation data includes a timestamp that corresponds to the most recent update and/or modification of the location data sets. Some embodiments provide that a counter value may be provided that increments each time the location data sets are modified.

Additionally, in some embodiments, if the mobile terminal 100 includes the GPS receiver 210 and is thus able to determine its geographical location using GPS signals, then the location data sets stored in the position cache 265 may be used to selectively activate and/or power the WLAN/Bluetooth transceiver 260 in the mobile terminal 100. For example, when the GPS signals indicate that the mobile terminal is proximate a geographical location that corresponds to one of the wireless network transceivers 62, the WLAN/Bluetooth transceiver 260 may be powered to communicate with that wireless transceiver 62. By selectively powering the WLAN/Bluetooth transceiver 260, power consumption of the mobile terminal 100 may be reduced thereby extending battery life.

In some embodiments, the mobile terminal 100 may be configured to selectively power the cellular transceiver 235 after receiving and storing the location data sets. For example, a user may traverse the area within the cell 50a with the WLAN/Bluetooth transceiver on until the mobile terminal 100 receives a wireless network identification signal corresponding to a wireless network that is not associated with the cell 50a, which may indicate that the mobile terminal is outside the cell 50a. In this regard, power consumption of the mobile terminal 100 may be reduced thereby extending battery life.

After determining the geographical location of the mobile terminal 100, a graphical image may be provided on the display 255 that includes the geographical location relative to previously mapped locations. In some embodiments, previously mapped locations may be determined via a map data source that provides map data to the mobile terminal. Some embodiments provide that the map data is provided via a wireless network 60 and/or by the telecommunication network through a cellular base station 52. In some embodiments, the map data may be provided via a removable memory module (not shown).

Although FIG. 5 illustrates an exemplary software and hardware architecture that may be used to provide the mobile terminal 100 as shown in FIG. 1, it will be understood that the present invention is not limited to such a configuration, but is intended to encompass any configuration capable of carrying out the operations described herein.

Computer program code for carrying out operations of devices and/or systems discussed above with respect to FIGS. 1, 2 and 5 may be written in a high-level programming language, such as Java, C, and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

The present invention is described hereinafter with reference to message flow, flowchart and/or block diagram illustrations of methods, mobile terminals, electronic devices, communication networks, and/or computer program products in accordance with some embodiments of the invention. These message flow, flowchart and/or block diagrams further illustrate exemplary operations of navigation units having multiple operating modes and methods and computer program products for operating the same. It will be understood that each message/block of the message flow, flowchart and/or block diagram illustrations, and combinations of messages/blocks in the message flow, flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions specified in the message flow, flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the message flow, flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the message flow, flowchart and/or block diagram block or blocks.

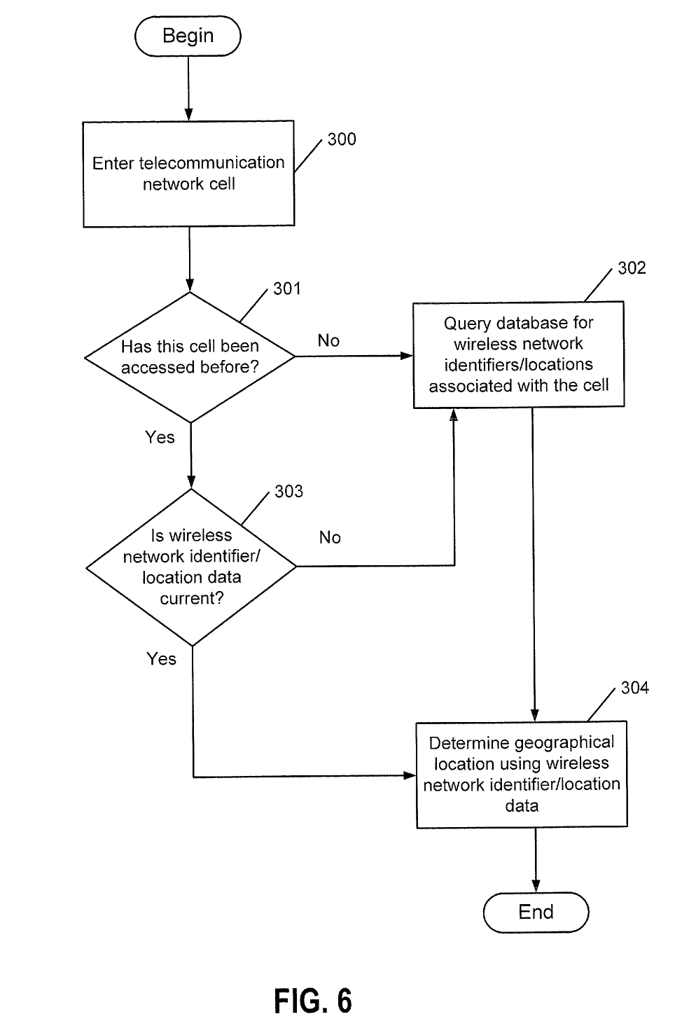

FIGS. 6-10 are flowcharts that illustrate operations of using the mobile terminal of FIG. 5 in accordance with some embodiments of the present invention. Reference is now made to FIG. 6, which is a flowchart illustrating operations for determining location and validating location data in accordance with some embodiments of the present invention. A mobile terminal 100 enters a telecommunication network cell 50a (block 300). If the cell 50a has not been accessed previously (block 301), then a wireless network location database 10 is queried for wireless network identifiers and corresponding geographical locations that are associated with the cell 50a (block 302). The corresponding location data sets are then transmitted to the mobile terminal 100.

If the cell 50a has been previously accessed by the mobile terminal 100, as evidenced by the presence of wireless network identifier/location data in the position cache 265 (block 301), then the wireless network identifier/location data is evaluated for validity (block 303). In some embodiments, evaluating the validity of the network identifier/location data may include requesting validation data from the wireless network location database 10, or a central repository thereof. If the wireless network identifier/location data is not valid (block 303), then the wireless network location database 10 is queried for the current wireless network identifiers and corresponding geographical locations that are associated with the cell (block 302), which are then transmitted to the mobile terminal 100. The geographical location of the mobile terminal 100 is then determined using the updated wireless network identifier/location data when a corresponding wireless network identification signal is received (block 304).

If the wireless network identifier/location data is valid (block 303), then the geographical location of the mobile terminal 100 is determined using the previously stored wireless network identifier/location data when a corresponding wireless network identification signal is received (block 304).

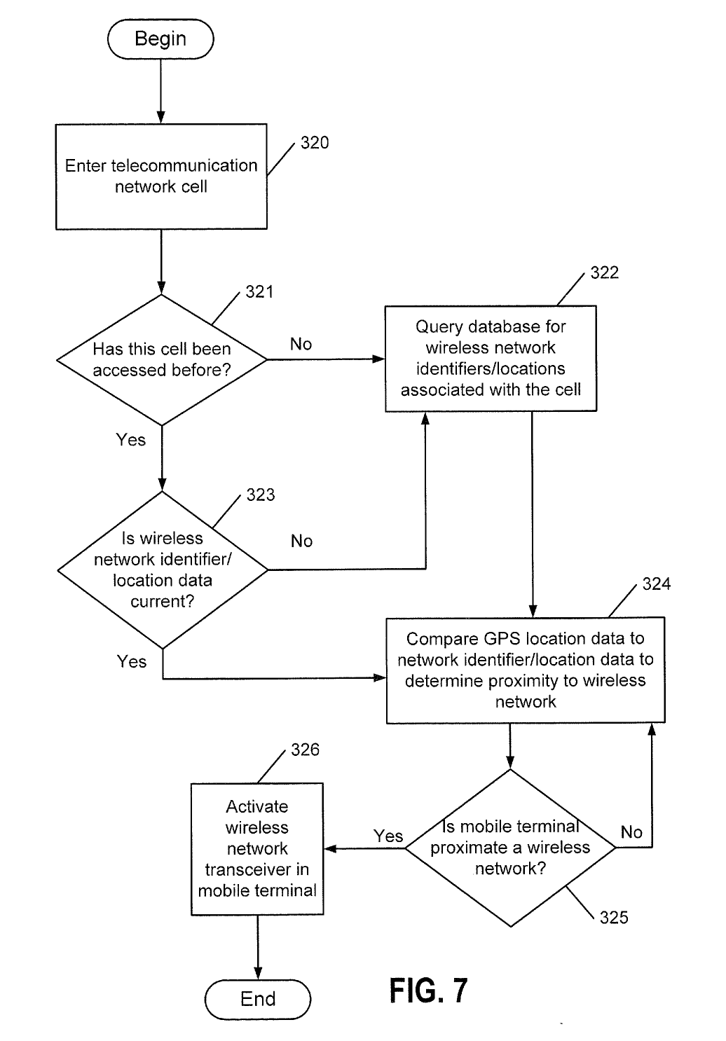

Reference is now made to FIG. 7, which is a flowchart illustrating operations for using wireless network location data in accordance with some embodiments of the present invention. A mobile terminal 100 enters a telecommunication network cell 50a (block 320). If the cell 50a has not been accessed before (block 321), then a wireless network location database 10 is queried for wireless network identifiers and corresponding geographical locations that are associated with the cell (block 322) and the location data sets are transmitted to the mobile terminal 100.

If the cell 50a has been previously accessed by the mobile terminal 100, as evidenced by the presence of wireless network identifier/location data corresponding to the cell 50a in the position cache 265 (block 321), then the wireless network identifier/location data is evaluated for validity (block 323). In some embodiments, evaluating the validity of the network identifier/location data may include requesting validation data from the wireless network location database 10, or a central repository thereof. If the wireless network identifier/location data is not valid (block 323), then the wireless network location database 10 is queried for the current wireless network identifiers and corresponding geographical locations that are associated with the cell 50a (block 322), which are then transmitted to the mobile terminal 100. After receiving the updated identifiers/locations associated with the cell 50a, the geographical location of the mobile terminal 100 as determined by received GPS signals is compared to the updated network identifier/location data to determine proximity to one of the wireless networks 60 (block 324).

If the wireless network identifier/location data is valid (block 323), then the geographical location of the mobile terminal 100, as determined by evaluation of the received GPS signals, is compared to the previously stored network identifier/location data to determine proximity to one of the wireless networks 60 (block 324). If the mobile terminal 100 is proximate a wireless network 60 (block 325) then the wireless network transceiver (WLAN/Bluetooth transceiver 260) in the mobile terminal 100 is activated, enabled and/or powered (block 326). In this manner, the power consumption of the wireless network transceiver may be reduced by selectively operating it when the mobile terminal 100 is proximate a wireless network 60. Accordingly, battery life of the mobile terminal 100 may be extended.

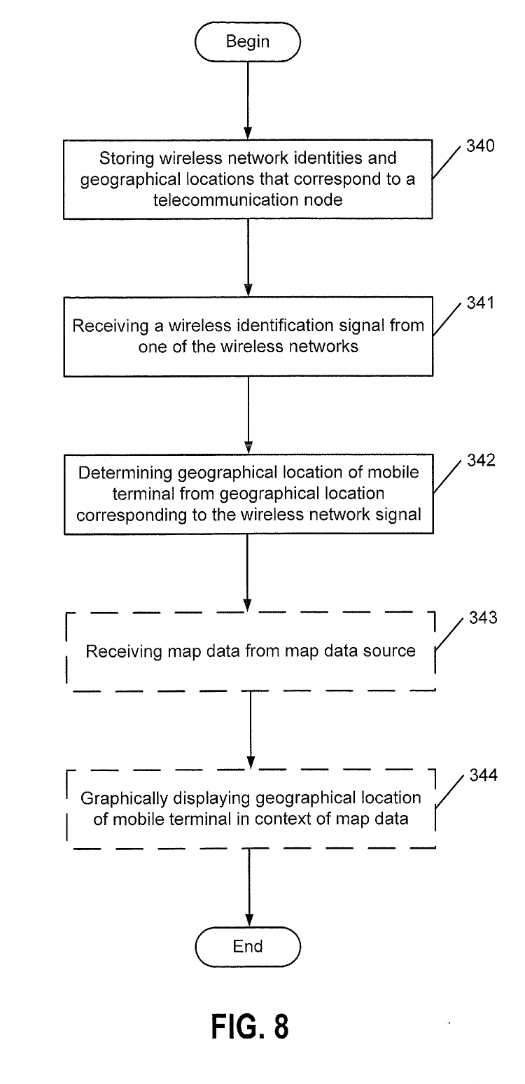

Reference is now made to FIG. 8, which is a flowchart illustrating operations for providing location data using a mobile terminal 100 in accordance with some embodiments of the present invention. Operations include storing, in a mobile terminal position cache 265, wireless network identities and corresponding geographical locations for each wireless network 60 that is associated with a wireless telecommunication node (cell) 50a in a wireless communication network (block 340). Some embodiments provide that the storing occurs responsive to communication between the mobile terminal 100 and a telecommunication transceiver 52a of the wireless telecommunication node 50a. For example, when a mobile terminal 100 enters a particular cell 50a in a cellular telecommunications system, identities of the wireless networks 60 that are associated with that cell 50a and their respective geographical locations may be transmitted to the mobile terminal 100 and stored in the position cache 265.

A wireless identification signal may be received by the mobile terminal 100 from one of the wireless networks 60 (block 341). The wireless identification signal may include, for example, a SSID and/or a MAC address of a WiFi wireless network 60, among others. A geographical location of the mobile terminal 100 may be determined (block 342) from the geographical location data that corresponds to that wireless network 60. In this manner, the location of the mobile terminal 100 may be determined based on data that is stored in the position cache 265.

In some embodiments, operations may optionally include receiving map data from a map data source (block 343). Some embodiments provide that the map data may be received via one or more of the wireless networks 60 and/or one or more of the telecommunication nodes 50. In some embodiments, the map data may be received via a removable memory device that may be placed in communication with the mobile terminal 100.

Some embodiments provide that operations optionally include graphically displaying the geographical location of the mobile terminal 100 in the context of the map data (block 344). For example, the location of the mobile terminal 100 may be displayed relative to other mapped features such as roads, intersections, naturally occurring topographical features and/or structures, among others.

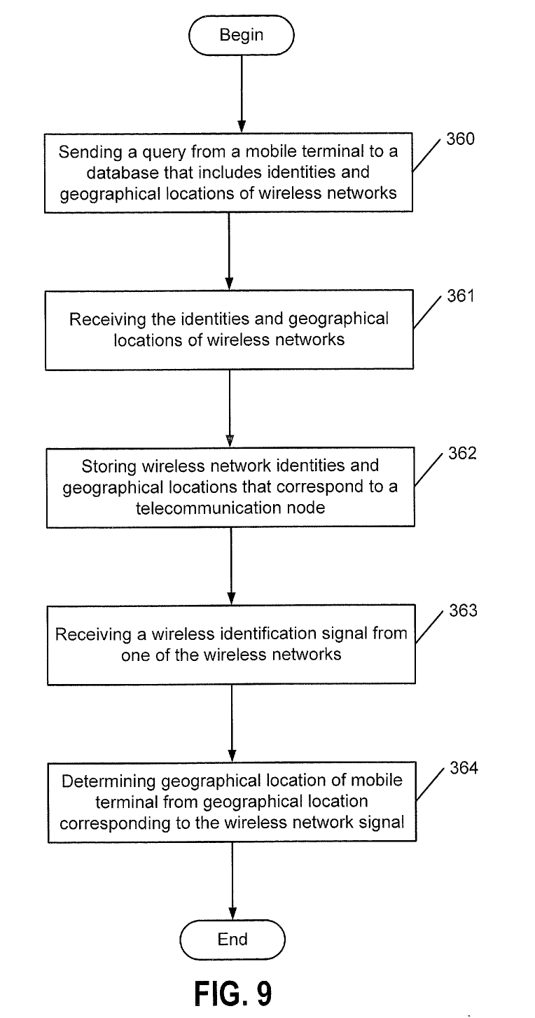

Reference is now made to FIG. 9, which is a flowchart illustrating operations for providing location data using a mobile terminal in accordance with some other embodiments of the present invention. Operations begin by sending a query from the mobile terminal 100 to a database 10 that includes the identities and corresponding geographical locations of wireless networks 60 that are associated with a telecommunication network node (cell) 50a (block 360). Some embodiments provide that the sending is performed by a telecommunication transceiver (cellular transceiver 235) in the mobile terminal 100. Operations include receiving, from the database, the identities and corresponding geographical locations of wireless networks 60 that are associated with and/or correspond to the telecommunication network node 50a (block 361).

The received wireless network identities and corresponding geographical locations for each wireless network 60 that are associated with the wireless telecommunication node 50a are stored in the mobile terminal position cache 265 (block 362). In this manner, when a mobile terminal 100 enters, for example, a particular cell 50a in a cellular telecommunications system, identities of the wireless networks 60 that are associated with that cell 50a and their respective geographical locations may be transmitted to the mobile terminal 100 and stored in the position cache 265.

A wireless identification signal may be received by the mobile terminal 100 from one of the wireless networks 60 (block 363). The wireless identification signal may include, for example, a SSID and/or a MAC address of a WiFi wireless network 60, among others. A geographical location of the mobile terminal 100 may be determined (block 364) from the geographical location data that corresponds to that wireless network 60. In this manner, the location of the mobile terminal 100 may be determined based on data that is stored in the position cache 265.

Some embodiments may further include validating stored wireless network identities and corresponding geographical locations that correspond to the wireless telecommunication node 50a in response to subsequent reconnection to the node 50a. For example, when a mobile terminal 100 has previously stored the wireless network identities and geographical locations in the position cache 265 that are associated with a particular cell 50a and the mobile terminal 100 returns to the cell 50a, the stored identity/location data may be validated to determine if the identity/location data associated with that cell 50a has changed.

In some embodiments, validating may include comparing a stored validation value corresponding to the stored identity/location data with a current validation value that is received when the mobile terminal 100 reconnects to the cell 50a. For example, some embodiments provide that the validation values are “fingerprints” of the identity/location data, while some embodiments provide that the validation values are checksums of the identity/location data. In some embodiments, the validation values may include timestamps and/or counters that are incremented and/or updated when the identity/location data is modified.

Some embodiments may include receiving map data from a map data source and graphically displaying the geographical location of the mobile terminal 100 in a context of the corresponding map data. Some embodiments provide that the map data is received via one of the wireless networks 60 and/or the telecommunication node 50a.

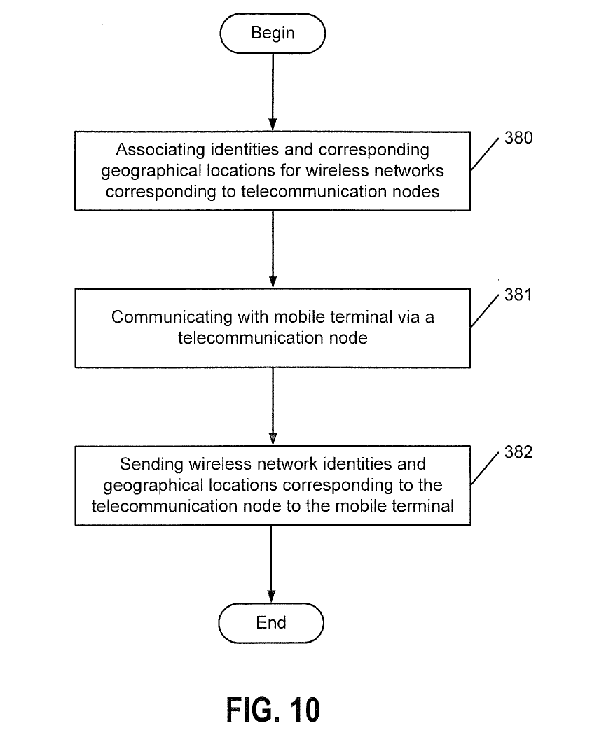

Reference is now made to FIG. 10, which is a flowchart illustrating operations for providing location data using a mobile terminal 100 in accordance with yet further embodiments of the present invention. Operations begin with associating identities and corresponding geographical locations for wireless networks 60 corresponding to telecommunication nodes 50 in a telecommunication network (block 380). Operations may include communicating with the mobile terminal 100 via one of the telecommunication nodes 50a (block 381). For example, when the mobile terminal 100 enters the area corresponding to the telecommunication node 50a, the mobile terminal 100 may query a database 10 that includes data corresponding to wireless networks therein. In response to communicating with the mobile terminal 100, wireless network identities and geographical locations corresponding to the telecommunication node 50a are sent to the mobile terminal 100 (block 382). In this manner, the mobile terminal 100 may store identity/location data for use within the telecommunication node 50a.

In the drawings and specification, there have been disclosed embodiments of the invention and, although specific terms are employed, they are used in a generic and descriptive sense only and not for purposes of limitation, the scope of the invention being set forth in the following claims.

That which is claimed:

1. A mobile terminal, comprising:
a position cache that is operable to receive, from a cellular network, a plurality of location data sets corresponding to a plurality of wireless local area networks (WLANs) that are associated with one of a plurality of cells in the cellular network when the mobile terminal is connected to the one of the plurality of cells;
a wireless network transceiver that is operable to receive WLAN identification signals from at least one of the plurality of WLANs when the mobile terminal is within range of a transceiver of the at least one of the plurality of WLANs; and
a position module that is operable to determine, from the position cache, a geographical location of the mobile terminal corresponding to at least one of the plurality of location data sets that corresponds to the at least one WLAN responsive to the received WLAN identification signals.

2. The mobile terminal of claim 1, further comprising a telecommunication network transceiver that is operable to query a database at the cellular network that includes the plurality of location data sets corresponding to the plurality of WLANs that are associated with the plurality of cells in the cellular and to receive the plurality of location data sets.

3. The mobile terminal of claim 1, wherein each of the plurality of location data sets comprises an identification of the corresponding one of the plurality of WLANs and the geographical location of the corresponding one of the plurality of WLANs.

4. The mobile terminal of claim 3, wherein the plurality of WLANs comprise WiFi networks, wherein the identification comprises a service set identifier (SSID) and/or a media access control (MAC) address, and wherein the geographical location comprises a longitude value and a latitude value.

5. The mobile terminal of claim 1, wherein the position cache is further operable to store validation data that corresponds to the plurality of location data sets corresponding to the plurality of WLANs that are associated with the one of the plurality of cells, and further comprising a validation module that is operable to use the validation data to determine if the plurality of location data sets is valid responsive to a subsequent reconnection to the one of the plurality of cells, wherein if the plurality of location data sets stored in the position cache is valid then a telecommunication network transceiver in the mobile terminal does not query a database at the cellular network.

6. The mobile terminal of claim 5, wherein the validation data comprises at least one hash value formed from the plurality of location data sets.

7. The mobile terminal of claim 5, wherein the validation data comprises a timestamp that corresponds to a latest update to the plurality of location data sets.

8. The mobile terminal of claim 5, wherein the validation data comprises an update counter value that increments when the plurality of location data sets is updated.

9. The mobile terminal of claim 1, wherein the ones of the plurality of location data sets corresponding to ones of the plurality of WLANs are associated with another one of the plurality of cells in the cellular network.

10. The mobile terminal of claim 1, wherein the position cache comprises a first-in first-out (FIFO) prioritization scheme and wherein the position cache is operable to discard the plurality of location data sets corresponding to a storage time that exceeds a predefined data validity period.

11. The mobile terminal of claim 1, further comprising:
a graphical image generator that is configured to generate a graphical image that includes the geographical location relative to previously mapped locations; and
a user display that is operable to display the generated graphical image.

12. The mobile terminal of claim 11, wherein the previously mapped locations are determined via a map data source that provides map data to the mobile terminal via at least one of the plurality of WLANs and/or at least one of the plurality of cells.

13. A method of providing location data using a mobile terminal, the method comprising:
storing, in a mobile terminal position cache, identities and corresponding geographical locations for each of a plurality of wireless networks that correspond to one of a plurality of wireless telecommunication nodes in a wireless telecommunication network responsive to communication with the one of the plurality of wireless telecommunication nodes;
receiving at least one wireless network identification signal from one of the plurality of wireless networks; and
determining a geographical location of the mobile terminal as a function of the geographical location corresponding to the at least one wireless network signal.

14. The method of claim 13, before storing, further comprising:
sending, via a telecommunication network transceiver in the mobile terminal, a query from the mobile terminal to a database that includes the identities and corresponding geographical locations; and
receiving, via the telecommunication transceiver, the identities and corresponding geographical locations for each of the plurality of wireless networks that correspond to the one of the plurality of wireless telecommunication nodes.

15. The method of claim 13, further comprising validating stored identities and corresponding geographical locations that correspond to the one of the plurality of wireless telecommunication nodes responsive to subsequent reconnection to the one of the plurality of wireless telecommunication nodes.

16. The method of claim 15, wherein validating comprises comparing a first validation value stored corresponding to storing the identities and corresponding geographical locations and a second validation value received responsive to the subsequent reconnection.

17. The method of claim 16, wherein the first and second validation values comprise first and second checksum values of the identities and corresponding geographical locations, first and second update counters corresponding to the identities and corresponding geographical locations and/or first and second update timestamps corresponding to the identities and corresponding geographical locations.

18. The method of claim 13, further comprising:
receiving map data from a map data source via at least one of the plurality of wireless networks and/or at least one of the plurality of wireless telecommunication nodes; and
graphically displaying the geographical location of the mobile terminal in a context of corresponding map data that is received from the map data source.

19. A computer program product for providing location data using a mobile terminal, the computer program product comprising a computer usable storage medium having computer readable program code embodied in the medium, the computer readable program code configured to carry out the method of claim 13.

20. A method of providing location data using a mobile terminal, the method comprising:
associating identities and corresponding geographical locations for each of a plurality of wireless networks with corresponding ones of a plurality of telecommunication nodes in a telecommunication network;
communicating with the mobile terminal via a first telecommunication node of the plurality of telecommunication nodes; and
sending, to the mobile terminal, ones of the identities and geographical locations corresponding to the first telecommunication node responsive to communicating with the mobile terminal.
